(19) United States
(12) Patent Application Publication
(10) Pub. No.: US 2025/0384772 A1
(43) Pub. Date: Dec. 18, 2025

(54) NOTIFICATION SYSTEM

(71) Applicant: ISUZU MOTORS LIMITED, Yokohama-shi (JP)

(72) Inventors: Yusuke TANAKA, Fujisawa-shi (JP); Akira NAKANISHI, Fujisawa-shi (JP); Ryuichiro OI, Fujisawa-shi (JP)

(21) Appl. No.: 19/217,257

(22) Filed: May 23, 2025

(30) Foreign Application Priority Data
Jun. 14, 2024 (JP) 2024-096676

(51) Int. Cl. G08G 1/16; B60N 2/90; G06V 20/59

(52) U.S. Cl. CPC G08G 1/166; G06V 20/597; B60N 2/90; B60N 2002/981

(57) ABSTRACT

A notification system includes an identifying part that identifies a state relating to a level of danger of a collision between an object, present ahead in a traveling direction of a vehicle, and the vehicle, and a notification control part that i) causes a display device, provided at a position visually recognizable by a driver of the vehicle, to display a first notification for alerting the driver of the vehicle when the state satisfies a first condition, and ii) causes the display device to display a second notification whose alert level is higher than the first notification and causes a vibration device, provided in a device in contact with the driver, to vibrate when the state satisfies a second condition in which a level of danger is higher than the first condition.

### CROSS-REFERENCE TO RELATED APPLICATIONS

The present application claims priority to Japanese Patent Applications No. 2024-96676, filed on Jun. 14, 2024, contents of which are incorporated herein by reference in their entirety.

### BACKGROUND OF THE INVENTION

The present disclosure relates to a notification system for notifying a vehicle driver of a danger.

A technique for notifying a vehicle driver of a danger is known. Japanese Unexamined Patent Application Publication No. H8-280006 discloses a technique in which a warning sound is output when a collision between a vehicle and an object around the vehicle is predicted based on the position and course of the object.

When a warning sound is output, not only a driver of a vehicle but also an occupant of the vehicle may recognize that the vehicle may collide with an object, and may cause excessive anxiety to the occupant.

### BRIEF SUMMARY OF THE INVENTION

The present disclosure focuses on this point, and an object thereof is to notify a driver of a danger without making an occupant aware of the danger.

### Means for Solving the Problems

An aspect of the present disclosure provides a notification system including an identifying part that identifies a state relating to a level of danger of a collision between an object, present ahead in a traveling direction of a vehicle, and the vehicle, and a notification control part that i) causes a display device, provided at a position visually recognizable by a driver of the vehicle, to display a first notification for alerting the driver of the vehicle when the identified state satisfies a first condition, and ii) causes the display device to display a second notification whose alert level is higher than the first notification and causes a vibration device, provided in a device in contact with the driver, to vibrate when the state satisfies a second condition in which a level of danger is higher than the first condition.

### BRIEF DESCRIPTION OF THE DRAWINGS

FIG. 1 is a diagram illustrating a notification system.

FIG. 2 is a schematic view of a driver's seat of a vehicle.

FIG. 3 is a diagram illustrating a configuration of a notification control device mounted on the vehicle.

FIG. 4 schematically shows an example of a first notification.

FIG. 5 schematically shows an example of a second notification.

FIG. 6 is a diagram illustrating a first vibration pattern.

FIG. 7 is a diagram illustrating a second vibration pattern corresponding to a posture abnormality.

FIG. 8 is a diagram illustrating a second vibration pattern corresponding to a distracted driving (inattentive driving) abnormality.

FIG. 9 is a flowchart illustrating an example of a process of alerting the driver.

### DETAILED DESCRIPTION OF THE INVENTION

Hereinafter, the present disclosure will be described through exemplary embodiments, but the following exemplary embodiments do not limit the invention according to the claims, and not all of the combinations of features described in the exemplary embodiments are necessarily essential to the solution means of the invention.

### [Configuration of Notification System S of First Embodiment]

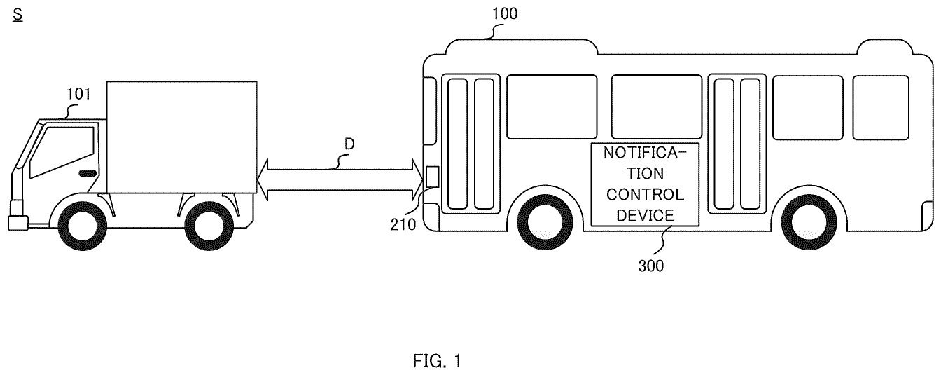

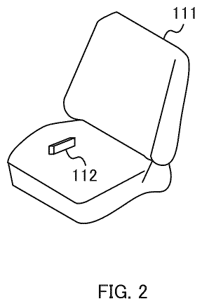

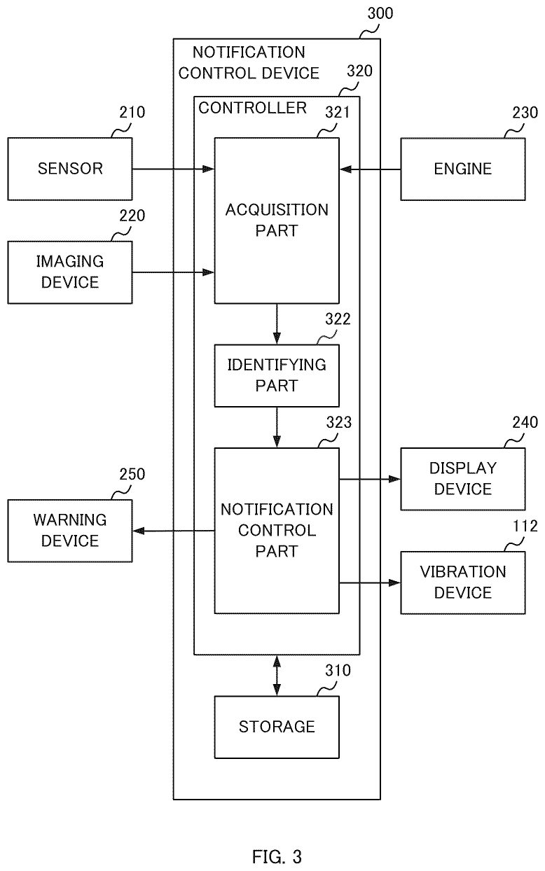

A notification system S according to the first embodiment is a system for alerting a driver of a vehicle. A configuration of the notification system S will be described with reference to FIGS. 1, 2, and 3. FIG. 1 is a diagram illustrating the notification system S. FIG. 2 is a schematic view of a driver's seat 111 of a vehicle 100. FIG. 3 is a diagram illustrating a configuration of a notification control device 300 mounted on the vehicle 100.

The vehicle 100 is a public transportation on which passengers ride, for example. The public transportation is a bus, for example, but is not limited thereto. The vehicle 100 is equipped with the driver's seat 111, a sensor 210, an imaging device 220, an engine 230, a display device 240, a warning device 250, and the notification control device 300.

The driver's seat 111 is a seat on which a driver of the vehicle 100 sits (see FIG. 2). A vibration device 112 is provided inside a seat of the driver's seat 111. The vibration device 112 includes a motor and weight, provided on a rotation shaft of the motor, with its center of gravity offset. The vibration device 112 vibrates by rotating the rotation shaft and the weight. The vibration device 112 is not limited to be provided inside the seat of the driver's seat 111, and may be provided inside a backrest of the driver's seat 111, or to a device with which the driver comes into contact, such as a steering wheel of the vehicle 100 or a headset worn by the driver. In addition, the number of vibration devices 112 is not limited to one, and a plurality of vibration devices may be provided.

The sensor 210 is a sensor that detects an object around the vehicle 100 (see FIG. 3). The sensor 210 is provided at a front portion of the vehicle 100, for example, but may be provided at a rear portion and a side surface of the vehicle 100. The sensor 210 is a radar, a Laser Imaging Detection and Ranging (LIDAR), or an ultrasonic sensor, for example, but is not limited thereto.

The sensor 210 scans around the vehicle 100 to detect position information about a relative position of a surrounding object 101 with respect to the vehicle 100. The object 101 is another vehicle, a pedestrian, a bicycle, or the like located around the vehicle 100, for example. The sensor 210 scans a region ahead in the traveling direction of the vehicle 100 at predetermined time intervals to detect, as a relative position, a distance D between the object 101, present ahead in the traveling direction of the vehicle 100, and the vehicle 100. The predetermined time is 100 milliseconds, for example, but is not limited thereto. In the following description, unless otherwise identified, it is assumed that the object 101 is another vehicle present ahead in the traveling direction.

The sensor 210 detects a relative speed between the object 101 and the vehicle 100 at the time of detecting the distance D. For example, when a new distance D is detected, the sensor 210 detects, as the relative speed between the object 101 and the vehicle 100, a value obtained by dividing a difference between the new distance D and the distance D detected immediately before acquiring the new distance D by the predetermined time.

The imaging device 220 is provided at a position where the driver of the vehicle 100 can be imaged. For example, the imaging device 220 is provided at a position in the interior of the vehicle 100 where an area including the driver's seat 111 can be imaged. Specifically, the imaging device 220 is provided on an upper portion of an instrument panel or a windshield in the interior of the vehicle 100. The imaging device 220 generates a captured image obtained by imaging the area including the driver's seat 111 at predetermined time intervals. The predetermined time is 100 milliseconds, for example, but is not limited thereto.

The engine 230 is an internal combustion engine that generates power by combusting and expanding a mixture of fuel and air. The engine 230 is a diesel engine, for example, but may be a gasoline engine. The engine 230 vibrates due to motion of a piston of the engine 230 and combustion of an air-fuel mixture generated in a combustion chamber.

The display device 240 displays information for alerting the driver to the object 101 present ahead in the traveling direction of the vehicle 100. The display device 240 is a liquid crystal display capable of displaying information for alerting the driver, for example, but is not limited thereto. The display device 240 is provided at a position visible to the driver of the vehicle 100. For example, the display device 240 is provided at a position visible to the driver and invisible to an occupant of the vehicle 100. Specifically, the display device 240 is provided on an instrument panel.

The warning device 250 is provided in the vehicle interior and outputs sound to the vehicle interior. The warning device 250 is a speaker, for example, but may be a buzzer. The sound output by the warning device 250 can be perceived by both the driver and the occupant of the vehicle 100. In the following description, the occupant of the vehicle 100 is referred to as a passenger.

The driver of the vehicle 100 drives the vehicle 100 so as to appropriately maintain the distance D between the vehicle 100 and the object 101 that is a vehicle traveling ahead in the traveling direction of the vehicle 100. However, when the object 101 decelerates or the driver of the vehicle 100 cannot properly drive the vehicle 100, the distance D between the vehicle 100 and the object 101 may decrease. When the distance D between the vehicle 100 and the object 101 decreases, a probability of a collision between the vehicle 100 and the object 101 increases, and the safety of the vehicle 100 may decrease.

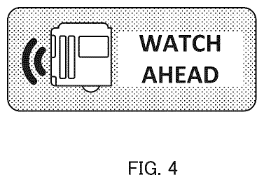

Accordingly, when the probability of the collision between the vehicle 100 and the object 101 increases, the notification control device 300 alerts the driver to the collision between the vehicle 100 and the object 101. Specifically, when the distance D between the vehicle 100 and the object 101 decreases and the probability of the collision increases, the notification control device 300 causes the display device 240 to display a first notification that alerts the driver of the vehicle 100 to the object 101. FIG. 4 schematically shows an example of the first notification. The first notification includes words “Watch Ahead” for alerting the driver to the object 101 present ahead in the traveling direction of the vehicle 100. The background color of the first notification is yellow, and the color of the words “Watch Ahead” is black, but are not limited thereto. The driver is alerted to the region ahead in the traveling direction of the vehicle 100 by visually recognizing the first notification displayed on the display device 240.

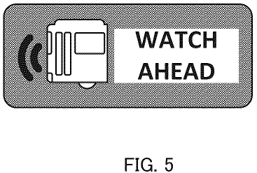

When the distance D between the vehicle 100 and the object 101 further decreases, the probability of the collision between the vehicle 100 and the object 101 further increases. Accordingly, after the first notification is displayed on the display device 240, the notification control device 300 raises an alert level for alerting the driver when the distance D decreases from the distance when the first notification is displayed. For example, the notification control device 300 causes the display device 240 to display a second notification having a higher alert level than the first notification. FIG. 5 schematically shows an example of the second notification. The second notification includes the words “Watch Ahead” for alerting the driver to the object 101 present ahead in the traveling direction of the vehicle 100. The second notification is displayed in a background color different from that of the first notification. For example, the background color of the second notification is red, which more effectively alerts the driver than yellow, and the color of the words “Watch Ahead” is black, but are not limited thereto. The driver can recognize that the vehicle 100 and the object 101 are too close to each other by visually recognizing the second notification displayed on the display device 240.

Further, the notification control device 300 causes the display device 240 to display the second notification and also causes the vibration device 112 to vibrate. By perceiving the vibration of the vibration device 112 in addition to visually recognizing the second notification, the driver can easily grasp that the distance D between the vehicle 100 and the object 101 is short and the probability of the collision between the vehicle 100 and the object 101 is high.

It should be noted that the notification control device 300 does not perform notification using a warning sound when alerting the driver to the collision between the vehicle 100 and the object 101. In other words, when the second notification is displayed on the display device 240, the notification control device 300 vibrates the vibration device 112 instead of causing the warning device 250 to output the warning sound. In this way, the passenger of the vehicle 100 does not perceive the warning sound. That is, the notification system S can notify only the driver of a danger without notifying the passenger of the danger. As a result, the notification system S can alert the driver to the collision between the vehicle 100 and the object 101 without making the passenger aware of the danger.

### [Configuration of Notification Control Device 300]

The notification control device 300 includes a storage 310 and a controller 320. The storage 310 is a storage medium including a Read Only Memory (ROM), a Random Access Memory (RAM), a hard disk, and the like. The storage 310 stores a program executed by the controller 320.

The controller 320 is a calculation resource including a processor such as a Central Processing Unit (CPU). The controller 320 realizes the functions of an acquisition part 321, an identifying part 322, and a notification control part 323 by executing the program stored in the storage 310.

The acquisition part 321 acquires position information of the object 101 detected by the sensor 210. For example, the acquisition part 321 acquires the relative position between the object 101 and the vehicle 100 from the sensor 210. Specifically, the acquisition part 321 acquires the distance D between the object 101 and the vehicle 100 from the sensor 210 as the relative position. Further, the acquisition part 321 acquires, from the sensor 210, the relative speed between the vehicle 100 and the object 101 at the time when the distance D is acquired. In other words, the acquisition part 321 acquires the relative speed detected by the sensor 210 from the sensor 210.

The acquisition part 321 acquires a captured image generated by the imaging device 220. Each time the imaging device 220 generates a captured image, the acquisition part 321 acquires the generated captured image. Further, the acquisition part 321 may notify the imaging device 220 of an instruction to generate a captured image at predetermined time intervals, and may acquire the captured image generated by the imaging device 220 in accordance with the instruction.

The acquisition part 321 acquires the steering angle of the vehicle 100. For example, the acquisition part 321 acquires, as the steering angle of the vehicle 100, an angle detected by a steering angle sensor provided on a steering wheel or a steering shaft of the vehicle 100. Further, the acquisition part 321 acquires an engine speed of the engine 230. For example, the acquisition part 321 acquires the engine speed detected by an engine speed sensor from the engine speed sensor provided on an output shaft of the engine 230.

The identifying part 322 identifies a state related to a level of danger of the collision between the vehicle 100 and the object 101. For example, the identifying part 322 identifies the probability of the collision between the object 101 and the vehicle 100 as a state related to the level of danger of the collision between the vehicle 100 and the object 101, based on the position information. Specifically, the identifying part 322 identifies a higher probability of collision when the acquired distance D is shorter. For example, the identifying part 322 identifies the probability corresponding to the acquired distance D by inputting the acquired distance D into a function that outputs a higher probability as the input distance D is closer to zero. In addition, the identifying part 322 may identify the probability according to the acquired distance D by referring to a data table in which the probability corresponding to each of the plurality of distances D is associated with each other.

The identifying part 322 may identify the probability of the collision using a predicted time until the vehicle 100 collides with the object 101. For example, the identifying part 322 identifies a predicted time determined by a ratio of the distance D to the relative speed, and identifies a higher probability of collision when the identified predicted time is shorter. As a specific example, the identifying part 322 identifies the probability corresponding to the identified predicted time by inputting the identified predicted time to a function that outputs a higher probability as the input predicted time is closer to zero. In addition, the identifying part 322 identifies the probability corresponding to the identified predicted time by referring to the data table in which the probabilities corresponding respectively to the plurality of prediction times are associated with each other.

The notification control part 323 alerts the driver to the collision between the vehicle 100 and the object 101 by notifying the driver of information on the level of danger of the collision between the vehicle 100 and the object 101. The notification control part 323 alerts the driver to the collision between the vehicle 100 and the object 101 by controlling the vibration device 112, the display device 240, and the warning device 250. For example, the notification control part 323 causes the display device 240 to display the first notification (see FIG. 4) to alert the driver to the collision between the object 101, present ahead in the traveling direction of the vehicle 100, and the vehicle 100. Specifically, when the probability of the collision identified by the identifying part 322 is equal to or greater than a first threshold value (when a first condition is satisfied), the notification control part 323 causes the display device 240 to display the first notification, thereby alerting the driver to the collision between the vehicle 100 and the object 101.

The first threshold value is determined based on a distance at which the driver, upon perceiving the first notification, is capable of performing an avoidance operation to avoid the collision between the vehicle 100 and the object 101. The avoidance operation is at least one of a turning operation or a deceleration operation, for example. The first threshold value is determined based on a reaction time that elapses until the driver, who perceives the first notification, performs the avoidance operation, and a distance traveled by the vehicle 100 during that time. The first threshold value is set to a value equal to a probability when the distance D is five meters, for example. In addition, the first threshold value may be set to a value equal to a probability when the predicted time is three seconds. It should be noted that a specific value of the first threshold value is not limited to this, and may be appropriately set. The avoidance operation includes an operation of decelerating the vehicle 100 and an operation of changing the traveling direction of the vehicle 100, for example, but is not limited thereto.

When the probability of the collision between the vehicle 100 and the object 101 increases from the probability at the time of displaying the first notification on the display device 240 and the level of danger of the collision increases, the notification control part 323 raises the alert level for alerting the driver. For example, when the probability is equal to or greater than a second threshold value larger than the first threshold value (when a second condition having a higher level of danger than the first condition is satisfied), the notification control part 323 raises the alert level. The second threshold value is determined based on the distance D or the predicted time during which the driver, who perceives the second notification or the vibration of the vibration device 112, is capable of performing a mitigation operation to reduce the damage in the event of the collision between the vehicle 100 and the object 101. A specific value of the second threshold value is set to a value equal to the probability when the distance D is two meters or the probability when the predicted time is one second, but is not limited thereto. The mitigation operation is an operation of decelerating the vehicle 100, for example, but is not limited thereto.

When the probability is equal to or greater than the second threshold value, the notification control part 323 causes the display device 240 to display the second notification (see FIG. 5) and vibrates the vibration device 112. For example, the notification control part 323 vibrates the vibration device 112 in a first vibration pattern that alerts the driver to the object 101 present ahead in the traveling direction of the vehicle 100. The first vibration pattern is a pattern in which the vibration device 112 vibrates for a first activation time, then stops for a first stop time, which is shorter than the first activation time, and this operation is repeated a predetermined number of times.

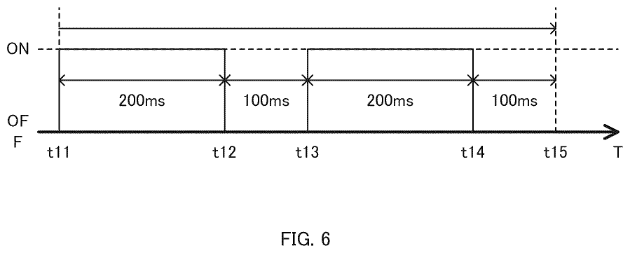

FIG. 6 is a diagram illustrating the first vibration pattern. The horizontal axis of FIG. 6 indicates time T. The first vibration pattern is a pattern in which the vibration device 112 vibrates for 200 milliseconds and then stops for 100 milliseconds, which is shorter than 200 milliseconds. The notification control part 323 causes the vibration device 112 to repeat the first vibration pattern twice. Specifically, the notification control part 323 causes the vibration device 112 to start vibration by causing a power source mounted on the vehicle 100 to supply power to the vibration device 112 at time t11 at which the probability becomes the second threshold value or higher. The power source is a storage battery, for example, but is not limited thereto. The notification control part 323 causes the power supply to stop the supply of power to the vibration device 112 at time t12, which is 200 milliseconds after time t11, thereby stopping the vibration of the vibration device 112. The notification control part 323 causes the vibration device 112 to start vibration at time t13, which is 100 milliseconds after time t12. The notification control part 323 causes the vibration device 112 to stop vibration at time t14, which is 200 milliseconds after time t13. It should be noted that the first vibration pattern is not limited to this.

After the vibration device 112 repeats the first vibration pattern twice, the notification control part 323 may cause the vibration device 112 to vibrate in the first vibration pattern again if the probability is equal to or greater than the second threshold value. At this time, the notification control part 323 may change the frequency at which the vibration device 112 vibrates. For example, the notification control part 323 causes the vibration device 112 to vibrate at a frequency higher than the frequency at which the vibration device 112 vibrated last time. Therefore, the driver can easily perceive the vibration of the vibration device 112, and thus can easily grasp that the probability of the collision is high.

If the vehicle 100 vibrates at the same frequency as the vibration of the vibration device 112, the driver may misinterpret the vibration of the vibration device 112 as the vibration of the vehicle 100 and fail to notice the vibration of the vibration device 112. Accordingly, the notification control part 323 makes the vibration of the vibration device 112 different from the vibration of the vehicle 100. For example, the notification control part 323 causes the vibration device 112 to vibrate at a frequency different from the frequency of vibration of the engine mounted on the vehicle 100. In this case, the notification control part 323 identifies the frequency (Hz) of the vibration of the engine. Since the frequency of the vibration of the engine approximately coincides with the engine speed of the engine, the notification control part 323 identifies the frequency (Hz) of the vibration of the engine by dividing the engine speed (rpm) of the engine by 60.

The notification control part 323 determines a frequency different from the frequency of the vibration of the engine by multiplying the identified frequency of the vibration of the engine by a predetermined value different from one. A specific example of the predetermined value is an integer other than one, but is not limited thereto. As described above, the notification control part 323 makes the frequency of the vibration of the vibration device 112 and the frequency of the vibration of the engine different from each other, so that the driver can easily perceive the vibration of the vibration device 112.

It should be noted that, in a general vehicle, when alerting a driver to a collision, notification is performed using a warning sound. However, the notification control device 300 according to the present embodiment does not perform notification using the warning sound when alerting the driver to the collision. Specifically, the notification control part 323 does not cause the warning device 250 to output the warning sound when causing the display device 240 to display the first notification. In addition, the notification control part 323 does not cause the warning device 250 to output the warning sound even when causing the display device 240 to display the second notification and causing the vibration device 112 to vibrate. In other words, even when there is the danger of the collision between the vehicle 100 and the object 101, the warning sound is not output in the vehicle 100. Therefore, the passenger of the vehicle 100 does not perceive the warning sound, and thus is not aware of the danger of the collision. As a result, the notification system S can notify only the driver of the danger of the collision without making the passenger aware of the danger.

When the vehicle 100, which is a bus, stops at a bus stop for a passenger to board or alight, the vehicle approaches the bus stop while turning and comes to a stop. When the vehicle 100 approaches the bus stop while turning, the distance D between a passenger waiting at the bus stop and the vehicle 100 decreases. However, since the bus stop is provided on a sidewalk and the driver of the vehicle 100 drives the vehicle 100 so that the vehicle 100 does not enter the sidewalk, the probability of a collision between the passenger on the sidewalk and the vehicle 100 is low.

Therefore, the notification control part 323 does not alert the driver when the vehicle 100 is turning. For example, when the steering angle of the vehicle 100 is equal to or greater than a predetermined angle, the notification control part 323 does not cause the vibration device 112 to vibrate even if the probability is equal to or greater than the second threshold value, and thus does not alert the driver to the collision. The predetermined angle is determined based on the steering angle at which the vehicle 100 turns at a bus stop, for example. One example of the predetermined angle is 30 degrees.

If the steering angle is equal to or greater than the predetermined angle, the notification control part 323 may not only refrain from causing the vibration device 112 to vibrate, but also may omit causing the display device 240 to display a display for alerting the driver. Specifically, when the steering angle is equal to or greater than the predetermined angle, the notification control part 323 does not cause the display device 240 to display the first notification even if the probability is equal to or greater than the first threshold value. In addition, when the steering angle is equal to or greater than the predetermined angle, the notification control part 323 does not cause the display device 240 to display the second notification even if the probability is equal to or greater than the second threshold value. This prevents the driver from visually recognizing unnecessary display or perceiving unnecessary vibration.

When the vehicle 100 is traveling straight without turning, the notification control part 323 alerts the driver to a collision. Specifically, when an absolute value of the steering angle is less than the predetermined angle and the probability is equal to or greater than the first threshold value, the notification control part 323 causes the display device 240 to display the first notification. Further, when the absolute value of the steering angle is less than the predetermined angle and the probability is equal to or greater than the second threshold value, the notification control part 323 causes the display device 240 to display the second notification and causes the vibration device 112 to vibrate. In this way, when the vehicle 100 is traveling straight, the notification control part 323 can alert the driver to the collision between the vehicle 100 and the object 101 present ahead in the traveling direction of the vehicle 100.

When the vehicle 100 turns toward a bus stop, another vehicle such as a pedal bicycle or a motorized bicycle may travel on a roadway adjacent to a sidewalk where the bus stop is provided. In this case, when the vehicle 100 approaches another vehicle traveling on the roadway, the probability of the collision increases. Therefore, even when the vehicle 100 is turning, if the probability of the collision between the vehicle 100 and the object 101, which is another vehicle present on the roadway, is high, the notification control device 300 alerts the driver to the collision.

A process of alerting the driver of the vehicle 100 during turning will be described below.

First, the identifying part 322 analyzes a captured image captured by a camera, capable of imaging a region ahead in the traveling direction of the vehicle 100, to identify a region that is the sidewalk and a region that is the roadway. Next, the identifying part 322 identifies whether the object 101 is present on the sidewalk or the roadway. Specifically, if the position of the object 101 is included in the region of the sidewalk, the identifying part 322 identifies that the object 101 is present on the sidewalk. If the position of the object 101 is included in the region of the roadway, the identifying part 322 identifies that the object 101 is present on the roadway.

If the object 101 having a high probability of a collision with the vehicle 100 is present on the roadway, the notification control part 323 alerts the driver to the collision. Specifically, if the probability of the collision between the object 101 located on the roadway and the vehicle 100 is equal to or greater than the first threshold value, the notification control part 323 causes the display device 240 to display the first notification. More specifically, the notification control part 323 causes the display device 240 to display the first notification if the steering angle is equal to or greater than the predetermined angle and the probability of the collision between the object 101 present on the roadway and the vehicle 100 is equal to or greater than the first threshold value. Further, if the steering angle is equal to or greater than the predetermined angle and the probability of the collision between the object 101 present on the roadway and the vehicle 100 is equal to or greater than the second threshold value, the notification control part 323 causes the display device 240 to display the second notification and causes the vibration device 112 to vibrate. In this way, when the vehicle 100 turns toward the bus stop, the notification control part 323 can alert the driver to the collision between the vehicle 100 and another vehicle traveling on the roadway adjacent to the sidewalk where the bus stop is provided.

The notification control part 323 does not alert the driver if the object 101 with the probability of the collision equal to or greater than the first threshold is present on the sidewalk. In other words, the notification control part 323 does not cause the first notification to be displayed if the object 101 is present on the sidewalk even when the probability of the collision between the object 101 and the vehicle 100 is equal to or greater than the first threshold value. More specifically, when the steering angle is equal to or greater than the predetermined angle and the object 101 with the probability of the collision equal to or greater than the first threshold value is present on the side walk, the notification control part 323 does not cause the display device 240 to display the first notification. In addition, when the steering angle is equal to or greater than the predetermined angle and the object 101 with the probability of the collision equal to or greater than the second threshold is present on the sidewalk, the notification control part 323 does not cause the display device 240 to display the second notification and does not cause the vibration device 112 to vibrate.

As described above, the notification control part 323 alerts the driver to the collision when the object 101 with the high probability of the collision is present on the roadway, and does not alert the driver to the collision when the object 101 having the high probability of the collision is present on the sidewalk. This allows the notification control part 323 to alert the driver in an appropriate situation where attention should be directed to a pedal bicycle, a motorized bicycle, or the like traveling on the roadway. In addition, the notification control part 323 can suppress unnecessary alerts to the driver in a situation where it is not necessary to draw the driver's attention to a passenger present on the sidewalk.

The notification control device 300 is capable of notifying the driver not only of collisions but also of other abnormalities. For example, when it is identified that the driver is in an abnormal state, the notification control device 300 notifies the driver that the abnormality has been identified by causing the vibration device 112 to vibrate. In this case, if the vibration device 112 vibrates in the same vibration pattern as the first vibration pattern that alerts the driver to the object 101, the driver is unable to distinguish whether the probability of the collision is high or an abnormality has been identified.

Accordingly, when alerting the driver to the abnormality, the notification control device 300 causes the vibration device 112 to vibrate in a second vibration pattern different from the first vibration pattern that alerts the driver to the high probability of the collision. This allows the driver to distinguish whether the probability of the collision is high or the abnormality has been identified.

A process of notifying the driver of the abnormality will be described below.

The identifying part 322 identifies whether the driver is in a normal state or abnormal state by analyzing a captured image obtained by imaging the driver. If the driver is identified to be in an abnormal state, the identifying part 322 analyzes the captured image to identify the type of abnormality of the driver. Specifically, the identifying part 322 identifies whether the driver is in a state of distracted driving or inattentive driving abnormality, or in a state of postural abnormality. The distracted driving or inattentive driving refers to a state where the driver is not focusing on the traveling direction of the vehicle 100. The postural abnormality refers to a state where the driver deviates from a normal driving posture.

When it is determined that the driver is in the abnormal state, the notification control part 323 causes the vibration device 112 to vibrate in the second vibration pattern corresponding to the identified type of abnormality of the driver. The second vibration pattern is a vibration pattern different from the first vibration pattern. Specifically, the second vibration pattern is different from the first vibration pattern in at least one of an activation time during which the vibration device 112 vibrates or a stop time during which the vibration device 112 stops vibration in a predetermined period. In addition, a second vibration pattern corresponding to the postural abnormality is different from a second vibration pattern corresponding to the distracted driving (inattentive driving). The second vibration pattern corresponding to the postural abnormality is a pattern in which the vibration device 112 vibrates for a second activation time, then stops for a second stop time shorter than the second activation time, and this operation is repeated a predetermined number of times. The second activation time of the second vibration pattern corresponding to the postural abnormality is longer than the first activation time of the first vibration pattern. Further, the second stop time of the second vibration pattern is longer than the first stop time of the first vibration pattern.

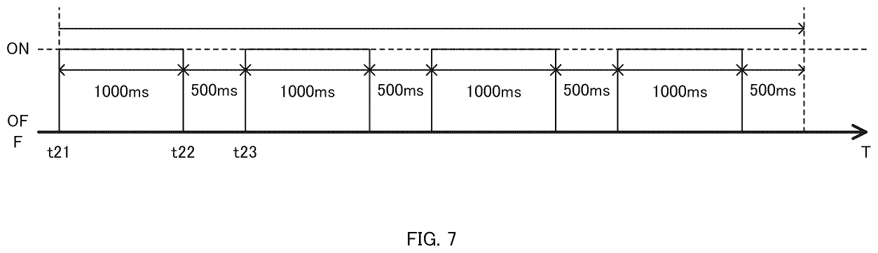

FIG. 7 is a diagram illustrating the second vibration pattern corresponding to the postural abnormality. The horizontal axis of FIG. 7 indicates time T. One example of the second vibration pattern corresponding to the postural abnormality is a pattern in which the vibration device 112 vibrates for 1000 milliseconds and stops for 500 milliseconds four times. The notification control part 323 causes the vibration device 112 to start vibration at time t21 at which the postural abnormality is identified. The notification control part 323 causes the vibration device 112 to stop vibration at time t22, which is 1000 milliseconds after time t21. The notification control part 323 causes the vibration device 112 to start vibration at time t23, which is 500 milliseconds after time t22. If the postural abnormality is identified even after the vibration device 112 repeats the start and the stop of the vibration four times, the notification control part 323 causes the vibration device 112 to repeat the start and stop of the vibration four times again. The notification control part 323 causes the vibration device 112 to vibrate in the second vibration pattern corresponding to the postural abnormality until the postural abnormality is not identified.

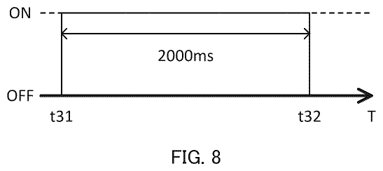

FIG. 8 is a diagram illustrating the second vibration pattern corresponding to the distracted driving (inattentive driving) abnormality. The horizontal axis of FIG. 8 indicates time T. The second vibration pattern corresponding to the distracted driving (inattentive driving) abnormality is a pattern in which the vibration device 112 vibrates for 2000 milliseconds and then stops the vibration. The notification control part 323 causes the vibration device 112 to start vibration at a time t31 at which the distracted driving (inattentive driving) abnormality is identified. The notification control part 323 causes the vibration device 112 to stop vibration at time t32, which is 2000 milliseconds after time t31. After stopping the vibration device 112, when the distracted driving abnormality is identified, the notification control part 323 causes the vibration device 112 to start vibration again. Specifically, if the distracted driving abnormality is identified after a predetermined time elapses after the vibration device 112 stops the vibration, the notification control part 323 causes the vibration device 112 to start vibration again. The predetermined time is shorter than the time period during which the vibration continues. A specific value of the predetermined time is 1000 milliseconds, for example, but is not limited thereto.

As described above, if it is identified that the driver is in the abnormal state, the notification control part 323 causes the vibration device 112 to vibrate in the second vibration pattern, which is different from the first vibration pattern for alerting the driver to the collision. In addition, the notification control part 323 causes the vibration device 112 to vibrate in the second vibration pattern according to the abnormality. Thus, the driver can grasp whether the distracted driving abnormality or the postural abnormality is identified. That is, the notification control part 323 can alert the driver to the identified abnormality.

When alerting the driver to the abnormality, the notification control part 323 causes the vibration device 112 to vibrate and does not cause the warning device 250 to output the warning sound. This allows the notification control part 323 to refrain from causing the warning device 250 to output the warning sound when notification to the passenger is unnecessary, thereby suppressing the passenger anxiety and notifying only the driver of the abnormality.

If the driver continues to be in the abnormal state even if the driver is alerted to the abnormality, the notification control part 323 determines that the driver is in a state incapable of driving the vehicle 100 and causes the vehicle 100 to stop. For example, the notification control part 323 causes the warning device 250 to output the warning sound, and then causes the vehicle 100 to stop. The warning sound is a buzzer, but may be an audio message of “An abnormality has occurred. Initiating emergency stop.” In this manner, when it is necessary to notify the passenger of the stop of the vehicle 100, the notification control part 323 can notify the passenger of the danger by causing the warning device 250 to output the warning sound.

### [Process of Alerting Driver]

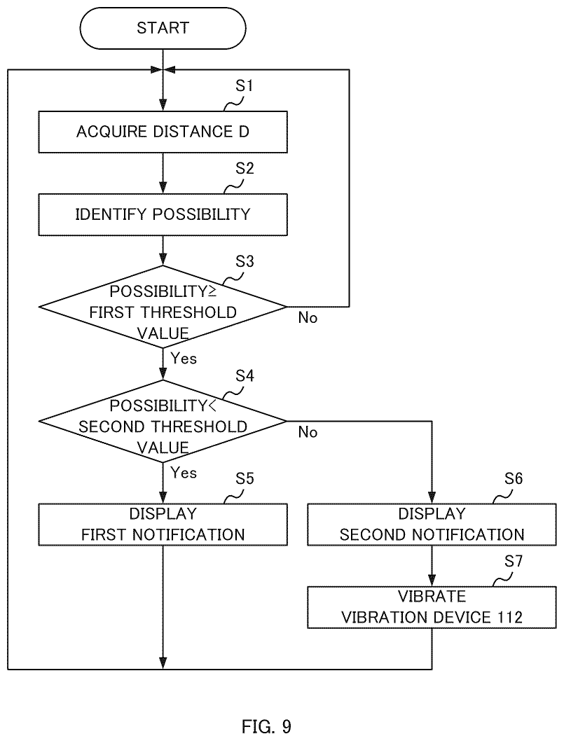

FIG. 9 is a flowchart illustrating an example of a process of alerting the driver. The process of alerting the driver is performed at predetermined intervals while the driver is seated in the driver's seat 111. The predetermined interval is 100 milliseconds, for example, but is not limited thereto.

The acquisition part 321 acquires the distance D between the vehicle 100 and the object 101 (step S1). Specifically, the acquisition part 321 acquires the distance D between the vehicle 100 and the object 101, which is the relative position detected by the sensor 210, from the sensor 210.

The identifying part 322 identifies the probability of the collision between the vehicle 100 and the object 101 (step S2). For example, the identifying part 322 identifies a higher probability as the distance D acquired by the acquisition part 321 is shorter. Specifically, the identifying part 322 identifies the probability corresponding to the acquired distance D by inputting the acquired distance D to a function that outputs a higher probability as the input distance D is closer to zero.

The notification control part 323 determines whether or not the identified probability is equal to or greater than the first threshold value (step S3). If the probability is less than the first threshold value (No in step S3), the notification control part 323 returns to step S1, and repeats the process from step S1 to step S3 until the probability becomes equal to or greater than the first threshold value.

If the probability is equal to or greater than the first threshold value (Yes in step S3), the notification control part 323 determines whether or not the probability is less than the second threshold value (step S4). If the probability is less than the second threshold value (Yes in step S4), the notification control part 323 causes the display device 240 to display the first notification (step S5). If the probability is greater than or equal to the second threshold value (No in step S4), the notification control part 323 causes the display device 240 to display the second notification (step S6). The notification control part 323 causes the display device 240 to display the second notification and also causes the vibration device 112 to vibrate in the first vibration pattern (step S7).

### Modified Example

The notification control device 300 performs a process of alerting the driver of the vehicle 100 not only when the vehicle 100 moves forward but also when the vehicle 100 moves backward. When the probability of the collision based on the distance between the object 101 and the vehicle 100 detected by a sensor provided on a rear surface of the vehicle 100 is high, the notification control device 300 alerts the driver to the collision between the vehicle 100 and the object 101.

### [Effects of the Notification System S According to First Embodiment]

As described above, the notification system S according to the first embodiment identifies the state related to the level of danger of the collision between the vehicle 100 and the object 101 present ahead in the traveling direction of the vehicle 100. If the identified state satisfies the first condition, the notification system S causes the display device 240, provided at a position visually recognizable by the driver of the vehicle 100, to display the first notification alerting the driver of the vehicle 100. If the state satisfies the second condition having a higher level of danger than the first condition, the notification system S causes the display device 240 to display the second notification having a higher alert level than the first notification, and also causes the vibration device 112, provided in the driver's seat 111 on which the driver sits, to vibrate.

When the notification system S causes the display device 240 to display the first notification or the second notification and also causes the vibration device 112 of the driver's seat 111 to vibrate, the driver can grasp that the vehicle 100 may collide with the object 101 or that the probability of the collision is high. In addition, the notification system S provides notification that the probability of the collision between the vehicle 100 and the object 101 is high by using the display visually recognizable by the driver and the vibration of the vibration device 112 provided in the driver's seat 111 on which the driver sits without outputting the warning sound. Therefore, the passenger in the vehicle 100 does not perceive the notification of the danger of the collision between the vehicle 100 and the object 101. That is, the notification system S can alert the driver to the collision between the vehicle 100 and the object 101 without making the passenger aware of the danger of the collision between the vehicle 100 and the object 101.

### [Notification System of Second Embodiment]

The identifying part 322 of the notification system S according to the first embodiment identifies the probability of the collision as the state related to the level of danger of the collision. However, the present disclosure is not limited thereto, and the identifying part 322 of the notification system S according to the second embodiment may identify whether the vehicle 100 is traveling straight or turning, and the state of the distance D between the object 101 and the vehicle 100, as the state related to the level of danger of the collision.

The identifying part 322 identifies whether the vehicle 100 is traveling straight or turning as the state related to the level of danger of the collision between the vehicle 100 and the object 101. The identifying part 322 identifies that the vehicle 100 is traveling straight when the absolute value of the steering angle of the vehicle 100 is less than the predetermined angle, and identifies that the vehicle 100 is turning when the absolute value of the steering angle of the vehicle 100 is equal to or greater than the predetermined angle.

The identifying part 322 identifies the state of the distance D between the object 101 and the vehicle 100 as the state related to the level of danger of the collision. The identifying part 322 identifies whether the distance D is in a state of being equal to or less than a first distance by determining whether the distance D is equal to or less than the first distance. The first distance is determined according to a distance at which the driver, who visually recognizes the first notification, is capable of performing the avoidance operation for avoiding the collision between the vehicle 100 and the object 101. The first distance is five meters, for example, but is not limited thereto.

The identifying part 322 identifies whether the distance D is in a state of being equal to or less than a second distance by determining whether the distance D is equal to or less than the second distance, which is shorter than the first distance. The second distance is determined according to a distance at which the driver, who visually recognizes the second notification or perceives vibration of the vibration device 112, is capable of performing the mitigation operation for reducing the damage in the event of the collision between the vehicle 100 and the object 101. The second distance is two meters, for example, but is not limited thereto.

If the vehicle 100 is traveling straight and the first condition that the distance D is equal to or less than the first distance is satisfied, the notification control part 323 causes the display device 240 to display the first notification (see FIG. 4). If the vehicle 100 is traveling straight and the second condition that the distance D is equal to or less than the second distance is satisfied, the notification control part 323 causes the display device 240 to display the second notification (see FIG. 4) and also causes the vibration device 112 to vibrate. The second condition is a condition in which the level of danger of the collision is higher than the first condition.

When the vehicle 100 is turning, the notification control part 323 does not cause the vibration device 112 to vibrate even if the distance D is equal to or less than the second distance. In addition, the notification control part 323 may omit causing the display device 240 to display a display for alerting the driver when the vehicle 100 is turning. Specifically, when the vehicle 100 is turning, the notification control part 323 does not cause the display device 240 to display the second notification even if the distance D is equal to or less than the second distance, and does not cause the display device 240 to display the first notification even if the distance D is longer than the second distance and equal to or less than the first distance.

### [Effects of the Notification System S of the Second Embodiment]

As described above, when alerting the driver to the collision between the vehicle 100 and the object 101, the notification system S according to the second embodiment can identify, as the state related to the collision of the vehicle 100, whether the vehicle 100 is traveling straight or turning, instead of the probability of the collision.

The present disclosure is explained on the basis of the exemplary embodiments. The technical scope of the present disclosure is not limited to the scope explained in the above embodiments and it is possible to make various changes and modifications within the scope of the disclosure. For example, all or part of the apparatus can be configured with any unit which is functionally or physically dispersed or integrated. Further, new exemplary embodiments generated by arbitrary combinations of them are included in the exemplary embodiments of the present disclosure. Further, effects of the new exemplary embodiments brought by the combinations also have the effects of the original exemplary embodiments.

1. A notification system comprising:
an identifying part that identifies a state relating to a level of danger of a collision between an object, present ahead in a traveling direction of a vehicle, and the vehicle; and
a notification control part that i) causes a display device, provided at a position visually recognizable by a driver of the vehicle, to display a first notification for alerting the driver of the vehicle when the identified state satisfies a first condition, and ii) causes the display device to display a second notification whose alert level is higher than the first notification and causes a vibration device, provided in a device in contact with the driver, to vibrate when the state satisfies a second condition in which a level of danger is higher than the first condition.

2. The notification system according to claim 1, comprising:
an acquisition part that acquires position information on a relative position between the object and the vehicle, wherein
the identifying part identifies a probability of the collision between the object and the vehicle as the state, based on the position information, and
the notification control part i) causes the display device to display the first notification when the first condition that the identified probability is equal to or greater than a first threshold value is satisfied, and ii) causes the display device to display the second notification and causes the vibration device to vibrate when the second condition that the probability is greater than or equal to a second threshold value, which is greater than the first threshold value, is satisfied.

3. The notification system according to claim 2, wherein
the identifying part identifies whether the driver is in a normal state or an abnormal state by analyzing a captured image of the driver, and
when the identifying part identifies that the driver is in the abnormal state, the notification control part causes the vibration device to vibrate in a second vibration pattern, which is different from a first vibration pattern that vibrates the vibration device when the probability is equal to or greater than the second threshold value.

4. The notification system according to claim 3, wherein
the first vibration pattern and the second vibration pattern are different from each other in at least one of an activation time during which the vibration device vibrates or a stop time during which the vibration device stops vibration in a predetermined period.

5. The notification system according to claim 3, wherein
the identifying part identifies a type of abnormality of the driver by analyzing the captured image, and
the notification control part causes the vibration device to vibrate in the second vibration pattern corresponding to the identified type.

6. The notification system according to claim 2, wherein
the acquisition part acquires a distance between the object and the vehicle as the relative position, and
the identifying part identifies a higher probability of collision when the distance is shorter.

7. The notification system according to claim 2, wherein
the acquisition part acquires a distance between the object and the vehicle as the relative position, and acquires a relative speed between the object and the vehicle at a time point when the distance is acquired, and
the identifying part identifies a higher probability of collision when a predicted time until the vehicle collides with the object, determined based on a ratio of the distance to the relative speed, is shorter.

8. The notification system according to claim 2, wherein
the notification control part causes the vibration device to vibrate at a frequency different from a frequency of vibration of an engine mounted in the vehicle.

9. The notification system according to claim 2, wherein
when a steering angle of the vehicle is equal to or greater than a predetermined angle, the notification control part does not cause the vibration device to vibrate even if the probability is equal to or greater than the second threshold value.

10. The notification system according to claim 9, wherein
when the steering angle is equal to or greater than the predetermined angle and the object is present on a sidewalk, the notification control part does not cause the vibration device to vibrate even if the probability is equal to or greater than the second threshold value.

11. The notification system according to claim 1, wherein
the vehicle is a public transportation in which a passenger rides, and
the notification control part does not cause a warning device mounted in the vehicle to output a warning sound i) when causing the display device to display the first notification, and ii) when causing the display device to display the second notification and the vibration device to vibrate.

12. The notification system according to claim 1, wherein
the vibration device is provided to a seat on which the driver sits.

13. The notification system according to claim 1, comprising:
an acquisition part that acquires a distance between the object and the vehicle, wherein
the identifying part identifies, as the state, whether the vehicle is traveling straight or turning, and
the notification control part i) causes the display device to display the first notification when the vehicle is traveling straight and the first condition that the distance is equal to or less than a first distance is satisfied, and ii) causes the display device to display the second notification and the vibration device to vibrate when the vehicle is traveling straight and the second condition that the distance is equal to or less than a second distance, which is shorter than the first distance, is satisfied.

14. The notification system according to claim 13, wherein
when the vehicle is turning, the notification control part i) does not cause the display device to display the first notification even if the first condition is satisfied, and ii) does not cause the display device to display the second notification and the vibration device to vibrate even if the second condition is satisfied.

15. The notification system according to claim 1, wherein
the identifying part identifies whether the object is present on a sidewalk or a roadway, and
the notification control part i) causes the display device to display the first notification when the object is present on the roadway and the state satisfies the first condition, and ii) does not cause, when the object is present on the sidewalk, the display device to display the first notification even if the state satisfies the first condition.
